(19) United States
(12) Patent Application Publication
(10) Pub. No.: US 2022/0234728 A1
(43) Pub. Date: Jul. 28, 2022

(54) Method and Apparatus for Reducing Download and Drag of VTOL Electric Vehicle

(71) Applicant: Bell Textron Inc., Fort Worth, TX (US)

(72) Inventors: Kirk L. Groninga, Keller, TX (US); Danielle L. Moore, Arlington, TX (US)

(73) Assignee: Bell Textron Inc., Fort Worth, TX (US)

(21) Appl. No.: 17/155,981

(22) Filed: Jan. 22, 2021

(51) Int. Cl. B64C 29/00; B64C 11/00; B64C 1/14; B64C 5/06; B64F 5/10; B64D 27/24; B64C 39/04; B64D 27/10

(52) U.S. Cl. CPC B64C 29/0016; B64C 11/00; B64C 1/1407; B64D 27/10; B64F 5/10; B64D 27/24; B64C 39/04; B64C 5/06

(57) ABSTRACT

A vertical takeoff and landing aircraft is described in which rotors can be disposed underneath the booms. This will allow for zero downward force resulting from thrust on the aircraft and therefore greater energy efficiency. Retractable doors can shield the rotors when not in use, decreasing drag during forward flight.

### TECHNICAL FIELD

The present disclosure is directed to aircraft design and more particularly to aerodynamic design for booms and rotors.

### BACKGROUND OF THE INVENTION

Electric vehicles are becoming more and more prevalent. Electric vehicles can be difficult to implement in aircraft because of the heavy weight of batteries. Because of the weight problem, any advantage in minimizing drag and download can be very valuable. Mitigating download can allow an aircraft to take off heavier.

### BRIEF SUMMARY OF THE INVENTION

One embodiment under the present disclosure can comprise a vertical takeoff and landing aircraft. The aircraft can comprise a fuselage and one or more wings coupled to the fuselage. It can further comprise one or more booms coupled to the fuselage by the one or more wings, wherein the one or more booms comprise one or more rotors on a ground facing side, and further comprising one or more doors operable to house the one or more rotors during forward flight and to retract and allow use of the one or more rotors during vertical takeoff and landing.

Another embodiment can comprise a method of manufacturing an aircraft for vertical takeoff and landing. The method can comprise providing a fuselage; coupling one or more wings to the fuselage; coupling one or more booms to the one or more wings; and coupling one or more rotors within the one or more booms, the one or more rotors ground-facing and operable for vertical takeoff and landing. It can further comprise providing one or more doors on the one or more booms, the one or more doors configured to house the one or more rotors during forward flight and to retract and expose the one or more rotors during vertical takeoff and landing.

Another embodiment under the present disclosure can comprise a method of operating an aircraft. The method can comprise retracting one or more doors located on one or more booms of the aircraft to reveal one or more rotors; providing thrust for vertical takeoff by the one or more rotors, wherein the one or more rotors are coupled to an underside of the one or more booms; once the aircraft is airborne, providing forward thrust and closing the one or more doors to conceal the one or more rotors within the one or more booms; slowing the aircraft and retracting the one or more doors to reveal the one or more rotors; and providing thrust for vertical landing by the one or more rotors.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 shows a prior art embodiment.

FIGS. 2A-2B show schematic views of an aircraft embodiment under the present disclosure.

FIGS. 3A-3D show schematic views of an aircraft embodiment under the present disclosure.

FIGS. 4A-4D show schematic views of an aircraft embodiment under the present disclosure.

FIG. 5 shows schematic views of an aircraft embodiment under the present disclosure.

FIGS. 6A-6E show door embodiments under the present disclosure.

FIGS. 7A-7B show door actuator embodiments under the present disclosure.

FIG. 8 shows a flow chart of a method embodiment under the present disclosure.

FIG. 9 shows a flow chart of a method embodiment under the present disclosure.

FIGS. 10A-10B show schematic views of an aircraft embodiment under the present disclosure.

### DETAILED DESCRIPTION OF THE INVENTION

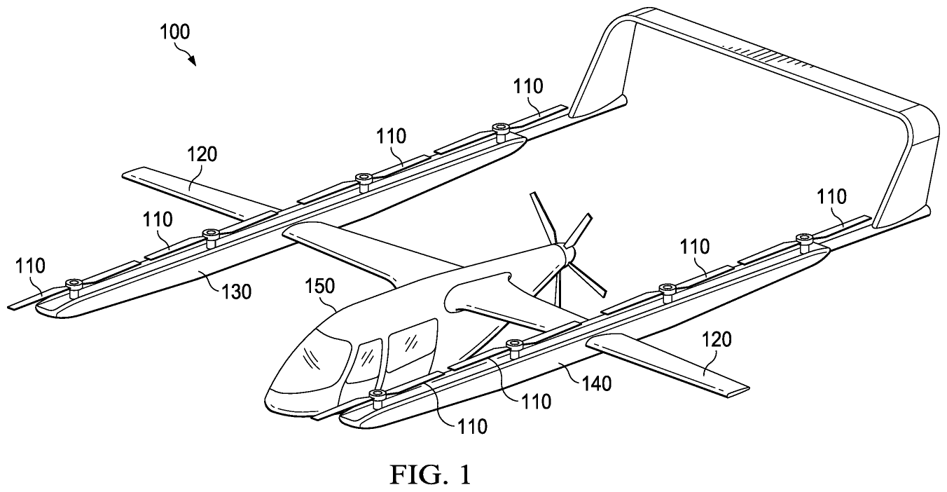

Referring now to FIG. 1, a prior art aircraft can be seen. Aircraft 100 comprises two booms 130, 140, cockpit and body 150, and wing 120. Rotors 110 sit on top of booms 130, 140. In the displayed configuration booms 130, 140 obstruct the thrust or thrust created by the rotors in hover mode. In forward flight, rotors 110 create drag. During flight the rotor blades are configured to sit parallel to the booms but drag is still created.

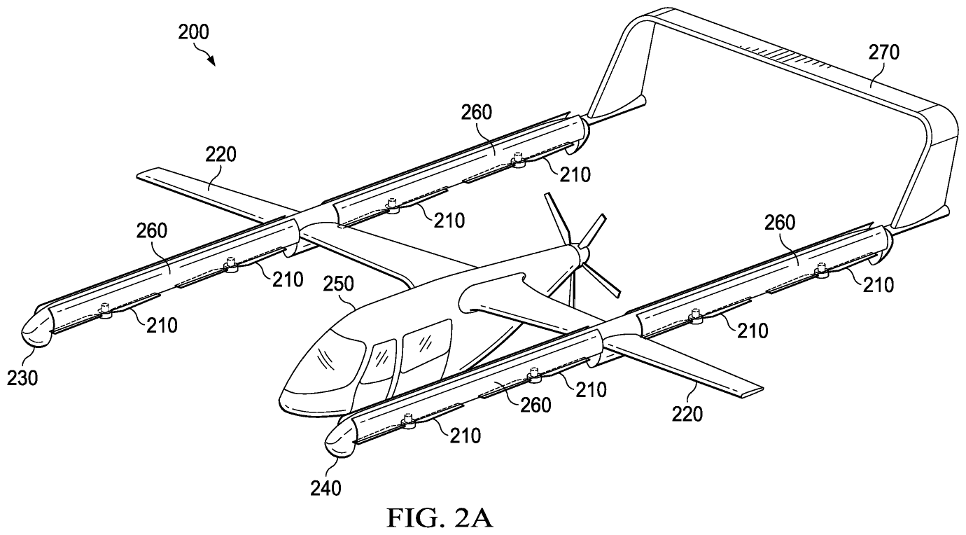

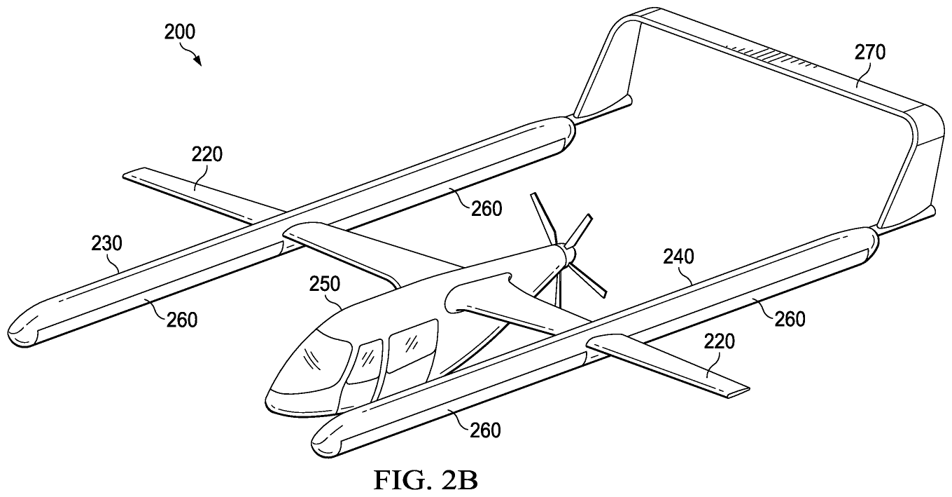

FIGS. 2A-2B, 3A-3D, and 4A-4D display an embodiment of a VTOL (vertical takeoff and landing) aircraft under the current disclosure.

As shown in FIG. 2A, embodiments under the present disclosure can comprise booms 230, 240 that comprise rotors 210 underneath. Aircraft 200 comprises booms 230, 240, fuselage 250, wing 220, and fin 270. Booms 230, 240 comprise doors 260 which can lift vertically to expose rotors 210. This embodiment allows the rotors 210 to apply maximum thrust during hover mode—because the boom does not get in the way. Furthermore, during forward flight, the doors 260 can be closed to prevent rotors 210 from creating drag. FIG. 2B shows aircraft 200 with the doors 260 closed such as in forward flight.

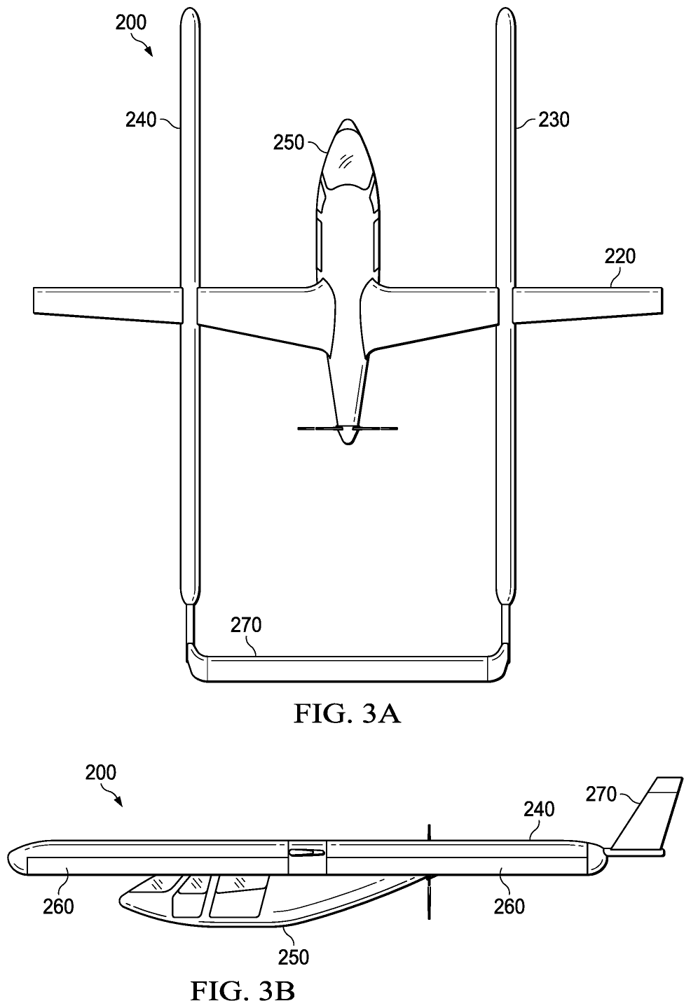

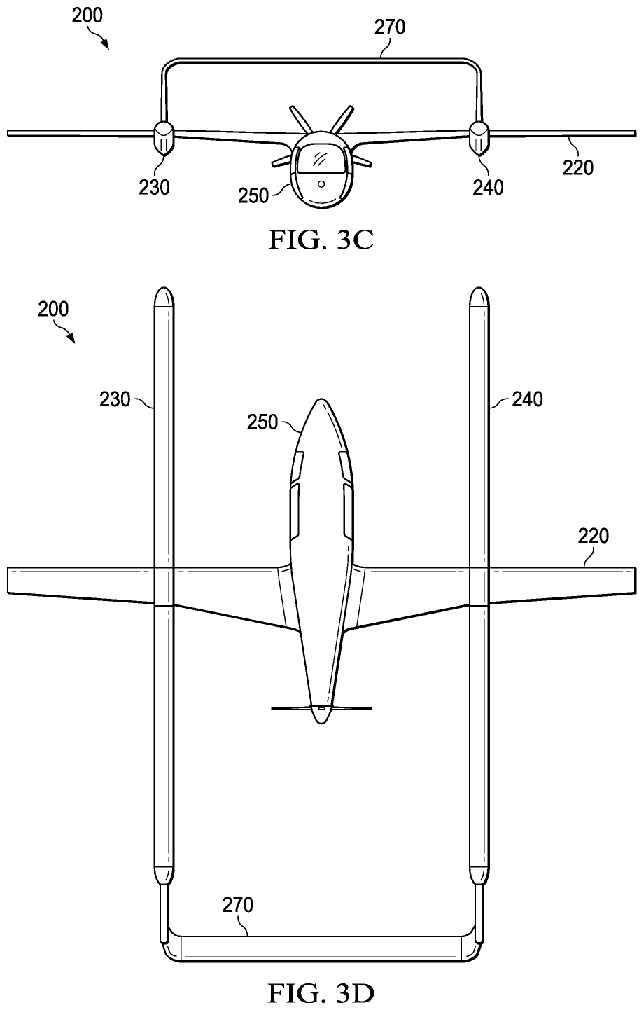

FIGS. 3A-3D show further views of aircraft 200 while the doors 260 are closed. FIG. 3A shows a top-down view. FIG. 3B shows a side-profile view. FIG. 3C shows a front view. FIG. 3D shows a bottom-up view.

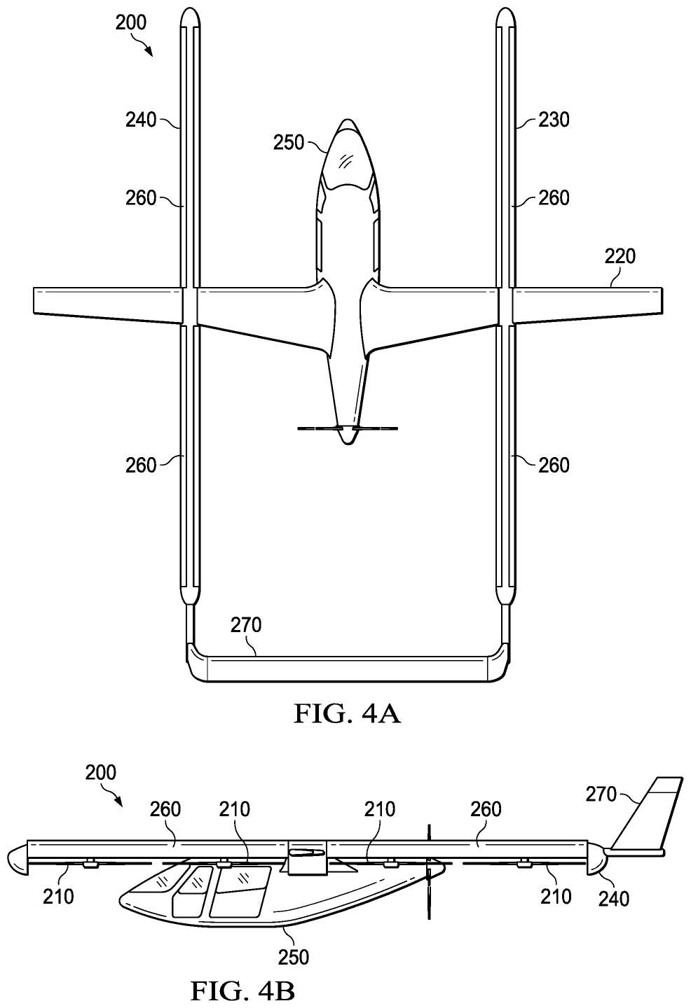

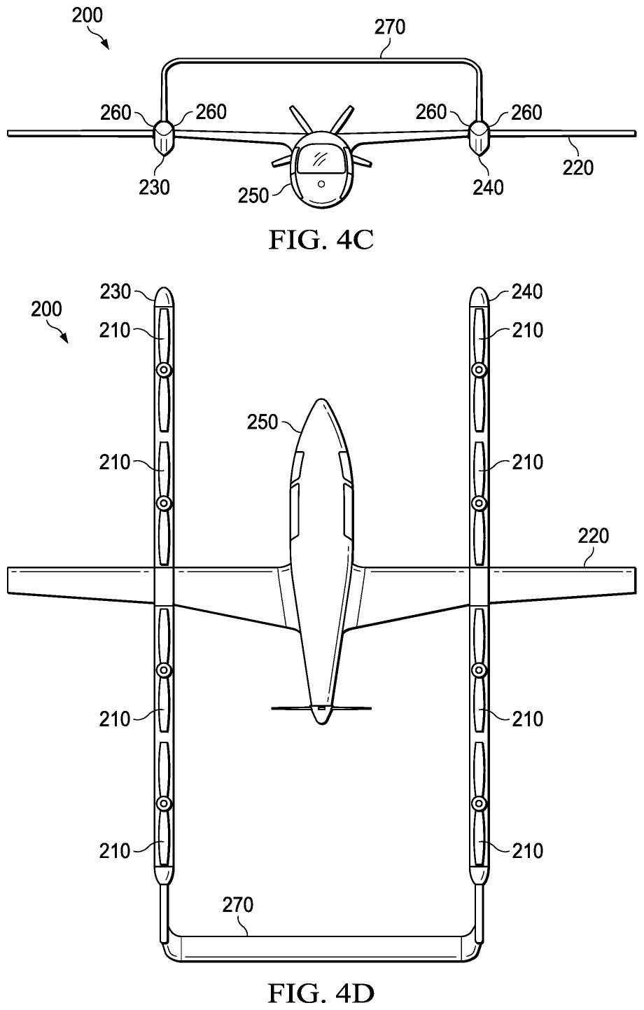

FIGS. 4A-4D show further views of aircraft 200 while the doors 260 are open. FIG. 4A shows a top-down view. FIG. 4B shows a side-profile view. FIG. 4C shows a front view. FIG. 4D shows a bottom-up view. As can be seen in FIG. 4C, doors 260 can be configured to sit close to booms 230, 240 even in open position. Furthermore, rotors 210, when not spinning, can be hidden from a front-view, also helping minimize drag.

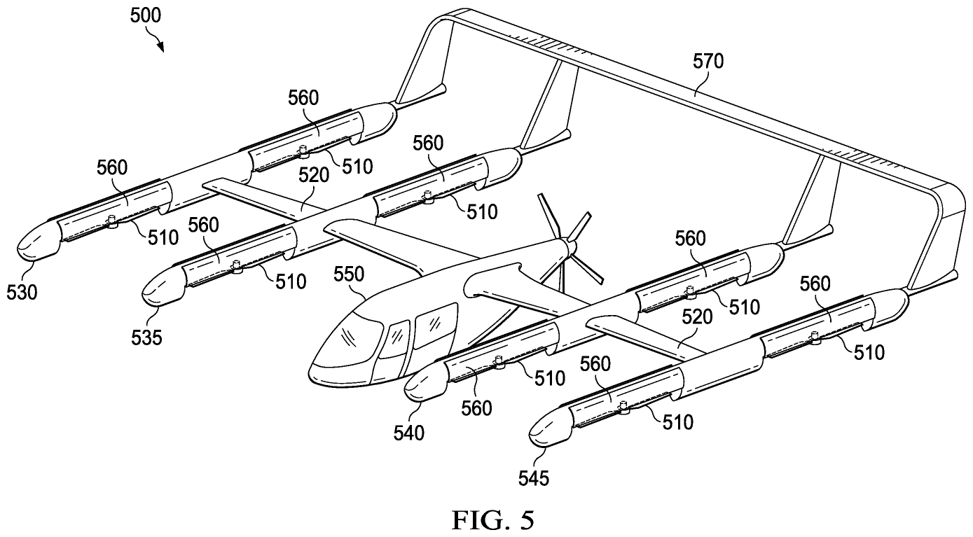

Aircraft 200 of the previous figures has been shown with eight rotors 210 and two booms 230, 240. However, the present disclosure includes other arrangements. For example, aircraft 500 of FIG. 5 comprises four booms 530, 535, 540, 545. Rotors 510 are located on each boom, but here there are two rotors 510 per boom. Fuselage 570, wing 520 and fin 570 are also shown. Doors 560 can open and close as in other embodiments. Any appropriate number of booms, wings, fins, and other elements are possible. It is preferred that each rotor comprise two blades in linear position with each other, such that the blades can rest within the boom during forward flight. While a preferred embodiment of the present disclosure comprises an electric aircraft, fuel-based aircraft are possible as well.

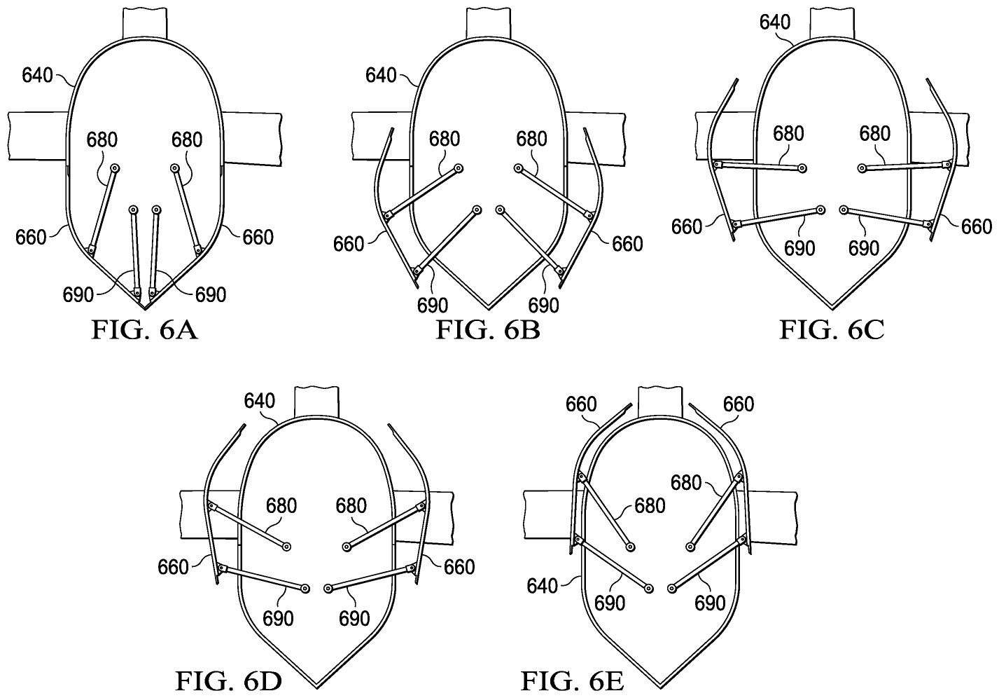

FIGS. 6A-6E show a possible embodiment of the doors on the booms shown in earlier figures. As seen, doors 660 are located on boom 640 and can house rotors (not shown). In this embodiment, a four-bar linkage comprising upper bars 680 and lower bars 690 can operate the opening and closing of doors 660. It is preferable that the default position of doors 660 be open (other arrangements are possible). That way, if there is a failure, the default position would be open, allowing the rotors to be used for takeoff and landing. Springs about the base of arms 680, 690 may be set to be neutral at the open position—and force would be used to maintain the doors 680, 690 in a closed position. Springs could be rotational about the base of arms 680, 690, or linearly actuated and connected at another part of arms 680, 690. It is preferable that the doors 660, when open as in FIG. 6E, rest close to the surface of boom 640. This will cause less drag.

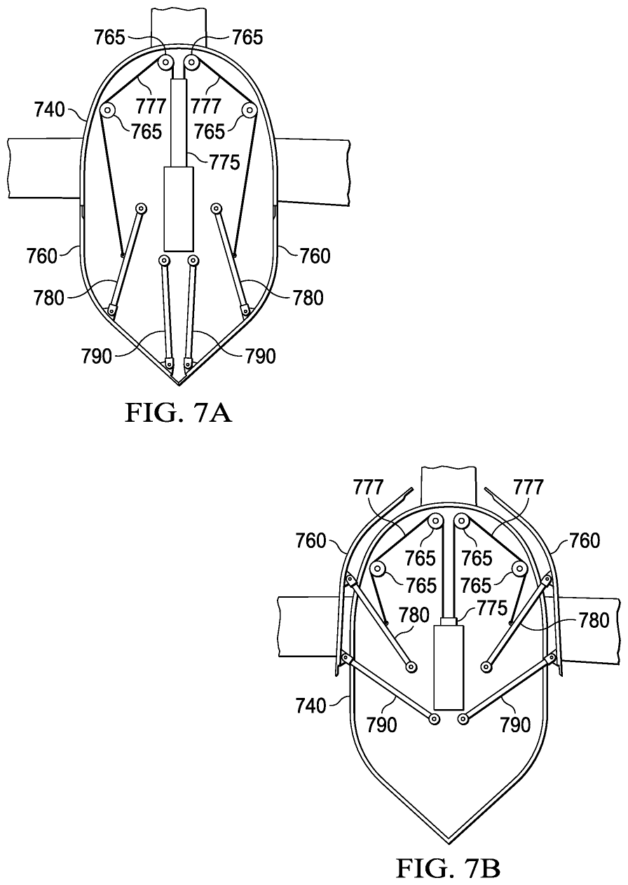

A variety of actuator options are available for moving arms 680, 690. A single linear actuator per door set is possible, operating both left and right doors simultaneously. A single linear actuator per boom is possible, or multiple actuators. FIGS. 7A and 7B show a possible actuator embodiment. Doors 760 are located on booms 740. Upper bars 780 and lower bars 790 can open and close doors 760. Actuator 775 show possible means of applying force to open or close doors 760. Actuator 775 can pull cable 777 that runs around pulleys 765 and connects to door 780. When actuator 775 lowers it pulls cable 777 and thereby opens door 760. FIG. 7A shows doors 760 in a closed state while FIG. 7B shows an open state. A variety of other actuator embodiments are possible.

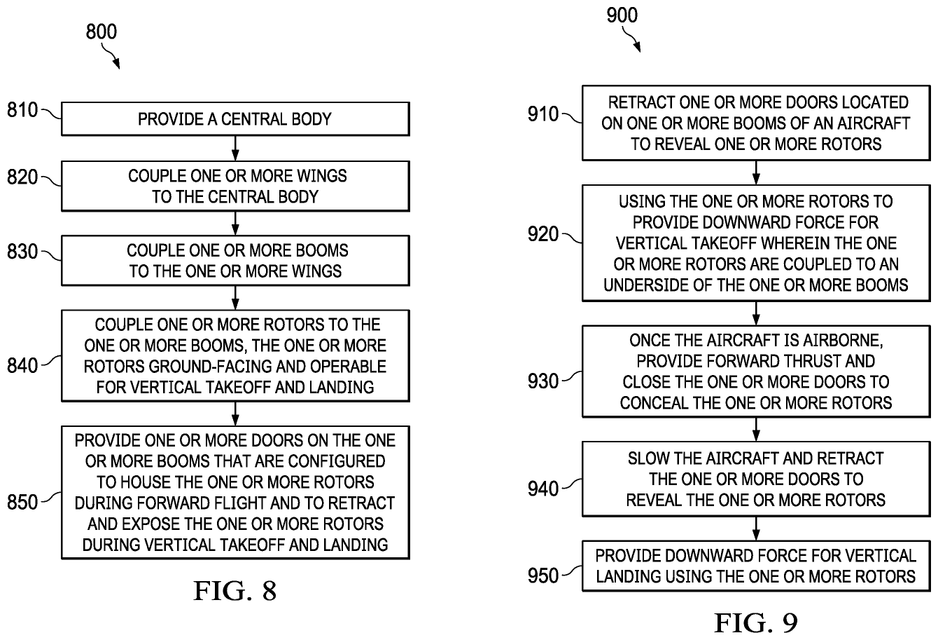

FIG. 8 shows a possible method embodiment 800 of manufacturing an aircraft under the present disclosure. At 810, a fuselage is provided. At 820, one or more wings are coupled to the fuselage. At 830, one or more booms are coupled to the one or more wings. At 840, one or more rotors are coupled within/to the one or more booms, the one or more rotors ground-facing and operable for vertical takeoff and landing. At 850, one or more doors are provided on the one or more booms, the one or more doors configured to house the one or more rotors during forward flight and to retract and expose the one or more rotors during vertical takeoff and landing.

FIG. 9 shows a possible method embodiment 900 for operating an aircraft under the present disclosure. At 910, one or more doors located on one or more booms can be retracted to reveal one or more rotors, wherein the one or more rotors are coupled to an underside of the one or more booms. At 920, the one or more rotors can provide thrust for vertical takeoff. At 930, once the aircraft is airborne, provide forward thrust and close the one or more doors to conceal the one or more rotors within the one or more booms. At 940, the aircraft can be slowed and the one or more doors can be retracted to reveal the one or more rotors. At 950, the one or more rotors provide thrust for vertical landing.

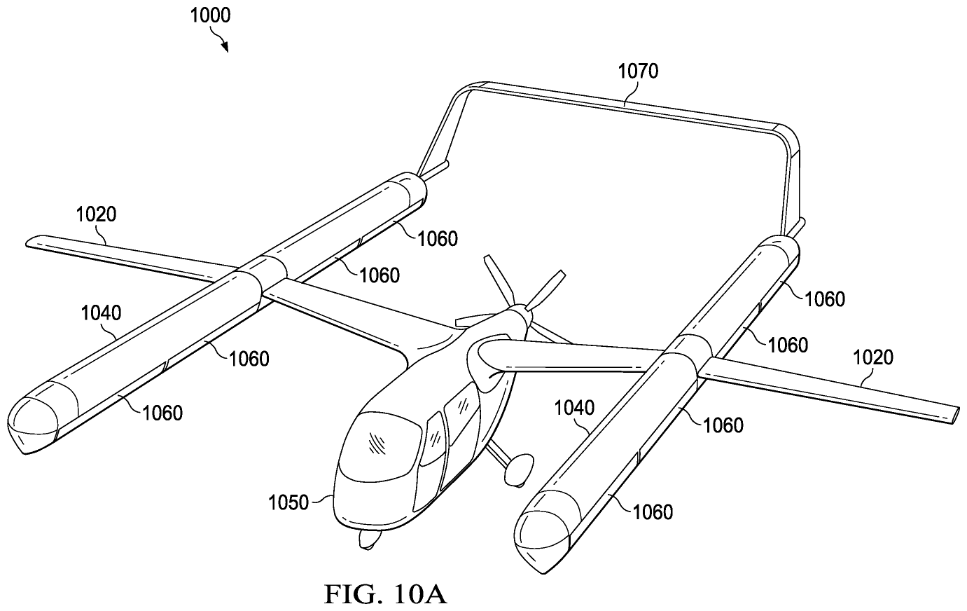

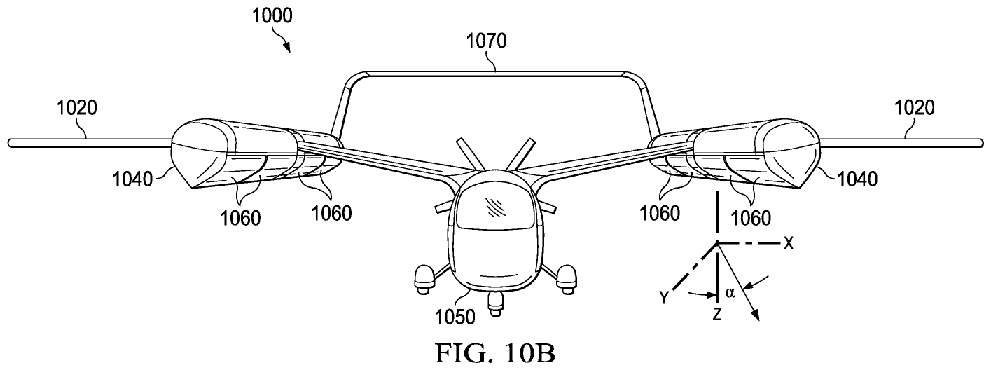

Another embodiment under the present disclosure can comprise an aircraft such as shown in FIG. 2, but with slightly canted booms. Such an embodiment would put the rotors at a slight outward-facing angle. This embodiment gives the aircraft some maneuverability advantages over non-canted embodiments. Such an embodiment can be seen in aircraft 1000 of FIGS. 10A-10B. Aircraft 1000 has booms 1040, fuselage 1050, and wings 2020. Doors 1060 are in a closed position concealing rotors (not shown). Booms 1040 can be canted slightly outward by an angle α. In this embodiment angle α is small, less than 10 degrees, but a variety of angles are possible. Wings 1020 are shown to extend upward from the fuselage at an angle. A portion of wings 1020 that are outboard of the booms 1040 can extend horizontally or at an angle. A variety of angled positions are possible for the wings 1020 and the booms 1040. One of the benefits of the embodiment of FIGS. 10A-10B is greater maneuverability for yaw.

Aircraft such as described in FIGS. 2 and 10 often have a hover mode and a forward flight mode. In hover mode, the rotors on the booms are used to provide lift. In order to pitch the aircraft, more thrust is provided to the front rotors (or rear rotors depending on the design). Thrust can be increased on one side or the other to achieve roll movement. To yaw the aircraft torque should increase on opposite rotors (front left and rear right rotors, for example). Ailerons and rudders can be used on the wings or fins to assist in aircraft movement, such as for yawing. An elevator can be used on a horizontal tail for additional maneuverability.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A vertical takeoff and landing aircraft comprising:
a fuselage;
one or more wings coupled to the fuselage;
one or more booms coupled to the fuselage by the one or more wings, wherein the one or more booms comprise one or more rotors on a ground facing side, and further comprising one or more doors operable to house the one or more rotors during forward flight and to retract and allow use of the one or more rotors during vertical takeoff and landing.

2. The aircraft of claim 1, wherein the one or more booms comprises one boom on each lateral side of the fuselage.

3. The aircraft of claim 1, wherein the fuselage comprises a central propeller configured to facilitate forward flight.

4. The aircraft of claim 2, wherein the one or more wings comprise one wing and wherein the one or more rotors comprises two rotors fore of the wing and two rotors aft of the wing.

5. The aircraft of claim 1, wherein the one or more doors have a neutral position of open.

6. The aircraft of claim 1, further comprising one or more four-bar linkages operable to open the one or more doors.

7. The aircraft of claim 1, further comprising a fin coupling together the one or more booms.

8. The aircraft of claim 1, wherein the one or more doors are configured to rest against the boom when open.

9. A method of manufacturing an aircraft for vertical takeoff and landing, comprising:
providing a fuselage;
coupling one or more wings to the fuselage;
coupling one or more booms to the one or more wings;
coupling one or more rotors within the one or more booms, the one or more rotors ground-facing and operable for vertical takeoff and landing; and
providing one or more doors on the one or more booms, the one or more doors configured to house the one or more rotors during forward flight and to retract and expose the one or more rotors during vertical takeoff and landing.

10. The method of claim 9, further comprising coupling a central propeller to the fuselage that is configured for forward flight.

11. The method of claim 9, further comprising providing an electrical power source to power the aircraft.

12. The method of claim 9, further comprising coupling a fin to the one or more booms.

13. The method of claim 9, wherein the one or more doors rest proximate an upper portion of the one or more booms when retracted.

14. The method of claim 9, wherein coupling one or more wings comprises coupling one wing and wherein coupling one or more rotors comprises coupling an equal number of rotors fore and aft of the one wing.

15. The method of claim 9, wherein the one or more rotors are coupled to the one or more booms such that all rotor blades can be placed linearly along the one or more booms and do not touch each other.

16. The method of claim 9, wherein four booms are coupled to the one or more wings.

17. A method of operating an aircraft for vertical takeoff and landing and forward flight, comprising:
retracting one or more doors located on one or more booms of the aircraft to reveal one or more rotors, wherein the one or more rotors are coupled to an underside of the one or more booms;
providing thrust for vertical takeoff by the one or more rotors;
once the aircraft is airborne, providing forward thrust and closing the one or more doors to conceal the one or more rotors within the one or more booms;
slowing the aircraft;
retracting the one or more doors to reveal the one or more rotors; and
providing thrust for vertical landing by the one or more rotors.

18. The method of claim 17 wherein forward thrust is provided by one or more propellers whose rotation of axis is parallel to the direction of forward flight.

19. The method of claim 17 wherein forward thrust is provided by an electric motor, an internal combustion engine or a turbine.

20. The method of claim 17 wherein retracting and closing the one or more doors comprises actuating a linear actuator.
